(19) United States
(12) Patent Application Publication
(10) Pub. No.: US 2009/0192913 A1
(43) Pub. Date: Jul. 30, 2009

(54) ELECTRONIC PAYMENT SYSTEM

(75) Inventors: Akira Saito, Zama-shi (JP); Takeyuki Shimura, Sagamirhara-shi (JP); Shigeki Takeuchi, Yokohama-shi (JP); Daisuke Tomoda, Yokohama-shi (JP); Hayato Uenohara, Tokyo (JP); Satoshi Yokoyama, Yokohama-shi (JP)

Correspondence Address: IBM CORPORATION;LOTUS SOFTWARE, ONE ROGERS STREET, CAMBRIDGE, MA, 02142, US

(73) Assignee: International Business Machines Corporation, Armonk, NY (US)

(21) Appl. No.: 12/354,048

(22) Filed: Jan. 15, 2009

(30) Foreign Application Priority Data
Jan. 29, 2008 (JP) 2008-18168

(51) Int. Cl. G06Q 30/00

(52) U.S. Cl. 705/26

(57) ABSTRACT

An electronic payment system includes a mobile apparatus, such as a mobile phone, with a memory for storing a list of electronic payment accounts that may be used to complete an electronic payment transaction. The electronic payment system further includes a merchant terminal that can receive the account list from the mobile apparatus. The merchant terminal retrieves account-related information for the accounts on the received account list and returns the account-related information to the mobile apparatus. The mobile apparatus uses the information from the merchant terminal to generate a set of payment method candidates. The set of candidates are presented to the user for selecting a payment method to be used. The payment method is sent to the merchant terminal for use in completing the pending transaction.

### BACKGROUND

The present invention relates to an electronic payment system that executes payment processing using a merchant terminal and e-payment (electronic payment) account information stored in a user's mobile device, such as a smartphone, a personal digital assistant or a converged form of such devices.

Recently, user mobile devices capable of storing different e-payment client applications (different credit cards, bank cards, debit cards, etc.) have been widely used. On the other hand, specifications for e-payment transactions are not standardized since merchant terminals have been dedicated to processing a particular type of e-payment transaction. However, merchant terminals capable of processing different types of e-payment transactions have begun to emerge. With the emergence of such merchant terminals, users now have options in selecting which of their e-payment accounts should be used in completing a transaction with the merchant.

While a user's mobile device may store basic information about the user's e-payment accounts, it may not store detailed information (account balances, e-payment provider current incentive programs such as discounts, points awards, etc.) that the user needs readily at hand in order to quickly make an intelligent account selection at the point of purchase. Furthermore, the user needs to verbally specify the e-payment method to be used and to authorize payment by causing a separate card or the mobile device to communicate with the merchant after a clerk initiates the payment transaction by entering the user's choice of the e-payment account to be used.

### SUMMARY

The invention may be implemented as a mobile apparatus for use in an electronic payment system also including a merchant terminal. The mobile apparatus includes a memory component for storing a list of electronic payment accounts that might be used in completing an electronic payment transaction. The mobile apparatus also includes a transmitting unit for sending the list to the merchant terminal and a receiving unit for receiving account-related information back from the merchant terminal. The account-related information includes account identifiers and additional information related to the accounts. The mobile apparatus also includes a payment method selection component for using the account-related information to generate a set of payment method candidates, each payment method candidate including the user of at least one of the electronic payment accounts. The mobile apparatus further includes a user input component for receiving a user's selection of one of the payment method candidates for use in completing an electronic payment transaction.

The invention may also be implemented as a method practiced in a mobile apparatus used in an electronic payment system that also includes a merchant terminal. The mobile apparatus includes and uses a memory component, a transmitting unit, a receiving unit and a payment method selection component. A list of electronic payment accounts that might be used in completing an electronic payment transaction is stored in the memory component. The list is sent to the merchant terminal. The user apparatus receives account-related information from the merchant terminal. The account-related information includes account identifiers and additional information. The account-related information is used to generate a set of payment method candidates. The user selects one of the payment method candidates from the generated set for use in completing an electronic payment transaction.

The invention may also be implemented as a computer program product for use in a mobile apparatus used in an electronic payment system that also includes a merchant terminal. The computer program product includes a computer-usable medium embodying computer usable program code that, when executed in the mobile apparatus, stores a list of electronic payment accounts in a memory component in the mobile apparatus, sends the list to the merchant terminal, receives account-related information back from the merchant terminal, uses the account-related information to generate a set of payment method candidates and receives a user's selection of one of the payment method candidates for using in completing an electronic payment transaction.

The invention may also be implemented as a merchant terminal for use in an electronic payment system that also includes a mobile apparatus. The merchant terminal includes a receiving unit for receiving a list of electronic payment accounts from the mobile apparatus, an information acquiring unit for retrieving account-related information for one or more of the accounts on the received list and a transmitting unit for returning the account list to the mobile apparatus with the account list and account-related information retrieved by the information acquiring unit.

The invention may also be implemented as a method practiced in a merchant terminal used in an electronic payment system that also includes at least one mobile apparatus. A list of electronic payment accounts is retrieved from the mobile apparatus. Information related to accounts on the list is retrieved and sent back to the mobile apparatus.

Finally, the invention may be implemented as a computer program product used in a merchant terminal in an electronic payment system that also includes a mobile apparatus. The computer program product includes a computer usable medium embodying computer usable program code that, when executed in the merchant terminal, causes a list of electronic payment accounts to be received from the mobile apparatus, causes account-related information to be retrieved for one or more of the accounts on the received list; and causes the account-related information to be sent to the mobile apparatus.

### BRIEF DESCRIPTION OF THE SEVERAL VIEWS OF THE DRAWINGS

FIG. 1 is a block diagram showing a configuration of an electronic payment system according to an embodiment.

FIG. 2 is a diagram showing a processing flow of electronic money payment processing in the case of displaying payment method candidates on a mobile phone of an electronic payment system.

FIG. 3 is a flowchart showing an electronic payment candidate selection processing of a mobile phone.

FIG. 4 is a diagram showing a screen of a mobile phone displaying payment method candidates.

FIG. 5 is a diagram showing a processing flow of electronic money payment processing in the case of displaying payment method candidates on an electronic payment terminal of an electronic payment system.

FIG. 6 is a diagram showing a screen of an electronic payment terminal displaying payment method candidates.

FIG. 7 is a diagram showing an information processing apparatus as an example of a typical hardware configuration of an electronic payment terminal.

FIG. 8 is a diagram showing a mobile phone apparatus as an example of a typical hardware configuration of a mobile phone

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

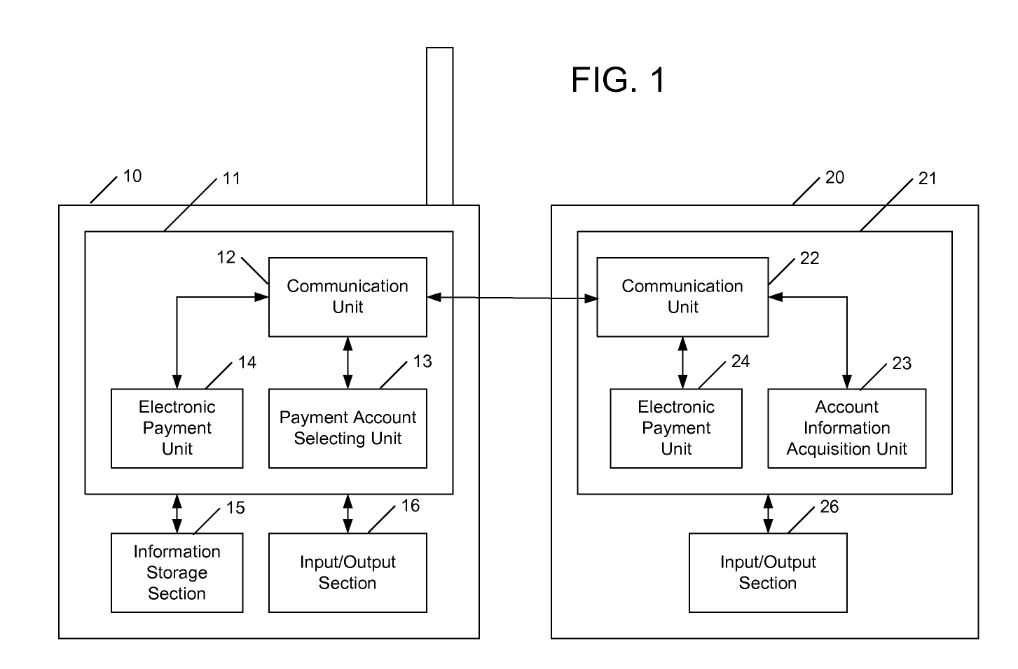

Embodiments of the present invention will be described below with reference to the drawings. FIG. 1 is a block diagram showing a configuration of an electronic payment system 1 according to an embodiment. The electronic payment system 1 includes a mobile phone 10 serving as a user mobile terminal and a merchant terminal 20 installed at a point of purchase; e.g., a retail store, a kiosk, etc. The merchant terminal 20 is capable executing transactions using different types of e-payment applications, such as bank cards, credit cards, debit cards, other on-line payment services such as the widely used PayPal™ payment service. The mobile phone 10 has an electronic payment function for making payment with a plurality of kinds of e-payment accounts, either individually or in combinations. The mobile phone 10 includes an electronic payment controlling section 11, an information storage section 15, and an input/output section 16. The electronic payment controlling section 11 includes a communication unit 12, an electronic payment candidate selecting unit 13, and an electronic payment unit 14 as main functional units. In addition, the merchant terminal 20 includes an electronic payment controlling section 21 and an input/output section 26. The electronic payment controlling section 21 includes a communication unit 22, an electronic money information acquiring unit 23, and an electronic payment unit 24 as main functional units.

Each functional section of the mobile phone 10 will be described below. The electronic payment controlling section 11 performs all of control operations regarding electronic payment processing. The communication unit 12 performs mutual exchange of electronic payment information with the communication unit 22 of the merchant terminal 20. Here, there are two communication methods, a “contact type” and a “contactless type”. The “contact type” is a method for performing data exchange using a contact terminal and is mainly used in a financial field, such as credit cards. On the other hand, the “contactless type” is a method for performing communication using an electromagnetic field by simply placing a card over a reader/writer and is used in transportation services, such as buses and trains, and payment at retail shops. Communication between the communication unit 12 of the mobile phone 10 and the communication unit 22 of the merchant terminal 20 may be either the “contact type” or the “contactless type”.

The e-payment account selecting unit 13 selects candidates for completing an e-payment transaction on the basis of an e-payment account list stored in the mobile phone 10, information acquired by the information acquiring unit 23 for accounts in the e-payment account list, and information stored in the information storage section 15. The electronic payment unit 14 exchanges information with the electronic payment unit 24 of the merchant terminal 20 to complete the electronic payment. The information storage section 15 stores the e-payment account list in the mobile phone 10 and information regarding electronic payments executed in the past by the user of the mobile phone 10, such as, for example, the various accounts used and amounts paid. The input/output section 16 may be buttons, a display, or the like on the mobile phone 10.

The input/output section 16 displays e-payment candidates for a proposed transaction and receives a user's selection of the account that is to be used for completing the transaction. For example, the candidates may be presented on a touch screen on the mobile phone 10 with the user's selection being received as a touch of a screen area associated with a particular candidate. As noted earlier, a candidate may involve a single account or a combination of accounts.

Each functional section of the merchant terminal 20 will be described below. The electronic payment controlling section 21 performs all of control operations regarding e-payment processing. As described above, the communication unit 22 acts as an interface to the communication unit 12 of the mobile phone 10. The account information acquiring unit 23 acquires usable/unusable state information of each kind of account indicating whether the account can be used (has sufficient funds, etc.) to complete the purchase transaction at the merchant terminal 20. Information acquiring unit 23 is also used to acquire additional account information for the accounts identified on the mobile phone 10 where the additional information might be useful to a user in deciding which of the available accounts to use. Examples of such additional information would be that a particular account provider is offering discounts or award points for use of the account; that is, information that would provide an incentive for the user to make use of the account in completing an electronic payment transaction. The electronic payment unit 24 exchanges information with the electronic payment unit 14 of the mobile phone 10 to complete an e-payment transaction as described above. The input/output section 26 may be a touch panel of the electronic payment terminal 20.

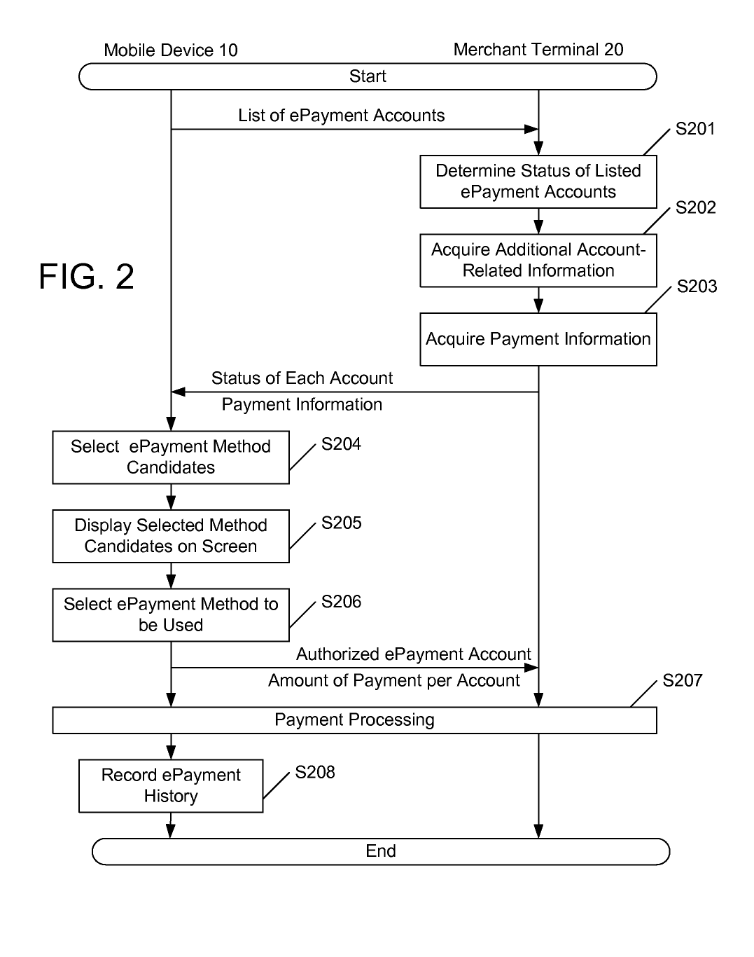

FIG. 2 is a diagram of a processing flow occurring in a system implementing the present invention. The merchant terminal 20 starts the processing when it detects and establishes communications with the user's mobile device 10. Initially, the mobile device 10 sends a list of the user's e-payment accounts that might be used in completing a transaction. The account list includes an account name and an ID of the user's account. The ID is an identifier for specifically identifying the account. Suppose, for example, that the user has five different e-payment accounts;

Account A (a Visa card from Bank A);

Account B (a Visa card from Bank B);

Account C (a store credit card);

Account D (a debit card from Bank A); and

Account E (a PayPal account).

The mobile phone 10 will store a list of all five accounts and will include account numbers or other information identified for the specific account held by the user. The list of the accounts and the account numbers are forwarded from the mobile phone 10 to the merchant terminal 20. Given the account names and account IDs, the merchant terminal 20 can acquire information as to which of the accounts might actually be used in consummating an electronic transaction. Simply because the user has a particular e-payment account does not mean that the particular account is a good candidate for a proposed electronic transaction. There are a number of reasons why a particular e-payment account may not be a suitable candidate. The account balance may be too low, the account may be expired, etc. The e-payment account information acquiring unit 23 acquires basic account usability information of the type described above in STEP S201.

For one or more of the accounts, the e-payment account information acquiring unit 23 may acquire additional information (STEP 202) relating not to basic account usability but rather to the desirability (from the user's perspective) of using a particular account for the particular transaction. Examples of such additional information include the presence or absence of the points awards, offers of special discounts to account users and information about account-related contests available to account users; e.g., notices that account use on the day of the transaction is to be “free for one out of 100 people!”. Information acquired by the merchant terminal 20 is associated to the accounts identified on the list provided by the user.

Subsequently, the merchant terminal acquires information specific to the proposed transaction (STEP 203), including the payment amount and terminal information (terminal identification information), such as an ID of a store executing the payment. The electronic payment controlling section 21 then communicates the collected information back to the mobile phone 10 through the communication units 22 and 12. Examples of the information that may be communicated back to the mobile phone 10 are shown below.

Account A: Usable, Points Not Available

Account B: Usable, Points Available (Point Return Rate 10%)

Account C: Usable, Points Not Available

Account D: Usable, Points Available, ×3

Account E: Unusable

Store ID: 0000000001

Amount of Payment: 500 dollars

The e-payment account selecting unit 13 selects (STEP 204) payment method candidates using the account list and the information provided by merchant terminal 20. The goal of the payment method selection process is to select a set of payment methods that is optimum for the user and to present the subset to the user for the user's final selection of one of the methods. In many cases, a payment method may consist of the use of a single account. In some cases, a payment method may consistent of the combined use of two or more accounts.

A method for selecting payment candidates will now be described. Several criteria may be used in selecting the payment methods. The balance currently available in an account to be used in the method is an obvious factor. Whether the user has actively used the particular account in the past is also a factor. The additional information acquired by the merchant terminal (the availability of reward points, discounts, etc) provides additional factors that are taken into account.

In addition, when the mobile phone 10 has a GPS (Global Positioning System), the user's current location (provided by the GPS) may be a factor the user should take into account in deciding whether nor not to complete the transaction. If one of the epayment accounts available to the user must also be used in providing electronic payment for commuting or other transportation costs in getting the user from his current location either to his office or his home, the user must be concerned whether nor not using that account will leave him short of needed transportation funds. By combining one or more conditions of the type described above, the payment method candidate selection process can be optimized for the user. The account selection criteria may be decided by a sales company of the mobile phone 10 in advance and stored in the mobile phone 10 or may be customized by a user.

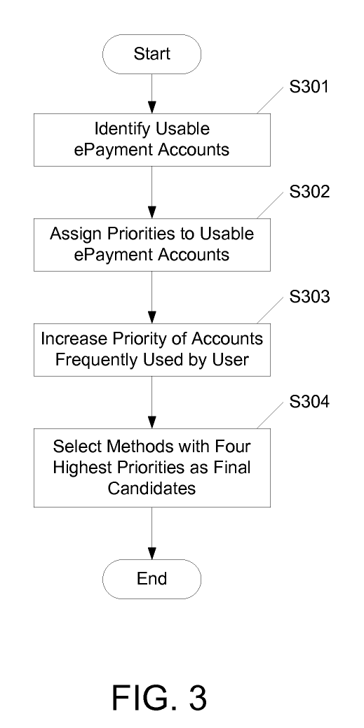

An example of a method for selecting e-payment method candidates for the benefit to a user will now be described. FIG. 3 is a flowchart showing an e-payment payment method selecting process that could be implemented on the mobile phone 10. When the mobile phone 10 receives the list of usable e-payment accounts and the payment information from the merchant terminal 20, the payment method candidate selection process starts. First, the electronic payment candidate selecting unit 13 identifies (STEP S301) usable accounts based on the basis of the remaining balance in each account and an amount of payment required for the proposed transaction. Account selection isn't necessarily limited to a single account. For example, when the remaining balance of one account is less than the amount to be paid, multiple accounts may be selected to provide to cover the total payment. The account selection unit 13 assigns priority (STEP 302) to the different methods determined to be usable at STEP S301, possibly on the basis of giving the highest priority to the single account that would have the largest balance if payment were made from the account, the presence or absence of reward points based on use of the account, point return rates, discount rates, etc.

Subsequently, the payment method selection unit 13 may re-order (STEP 303) the results of STEP 302 to increase the priority of an account used more frequently by the user. If there are more than four candidates, unit 13 selects (STEP 304) the four highest rated candidates for presentation to the user. While only a limited number of selection criteria are discussed above, it is within the scope of the invention to add more criteria or to rearrange the order in which the criteria are processed in selecting the account candidates that are presented to the user.

Referring back to FIG. 2, after the selection of the final set of payment method candidates at STEP S204, the input/output section 16 causes the candidates to be displayed (STEP 205) on the screen of the mobile phone 10. The calculated priority of each e-payment method, the account balances before and after the payment, and information about points and discounts are displayed on the screen. However, if the user does not have to select the method to be used, the candidates are not displayed on the screen of the mobile phone 10. This embodiment is described in more detail later.

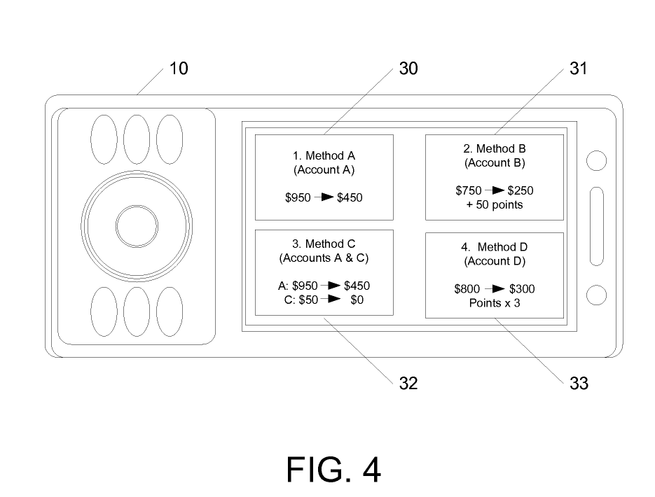

FIG. 4 is a diagram showing a screen of the mobile phone 10 displaying payment method candidates for four e-payment accounts: Method A, Method B, Method C and Method D. Generic names are used only for purposes of description. In a practical implementation, a method would probably be identified by the name of each account (e.g., Visa Card from First Citizens Bank) included in the method along with an account logo or logos. The screen is split into four windows and the top four payment method candidates are displayed. Within each window, a priority value, a payment method ID, and account balances before and after the payment are displayed. If information unique to each method exists, the additional information acquired at STEP S202 of FIG. 2 is also displayed. Specifically, a screen window 30 displays an e-payment method “Method A” with the highest priority, a pre-payment account balance of 950 dollars, and a post-payment account balance of 450 dollars. Method A may involve the use of a single bank credit card. Window 31 displays an e-payment method “Method B” with the second highest priority, a pre-payment balance of 750 dollars, and a post-payment account balance of 250 dollars. In addition, the window 31 indicates that will receive 50 points, which is 10% of the amount of payment, if the account is used in completing the transaction. Method B is also associated to a particular e-payment account.

On the other hand, window 32 displays a “combination” e-payment method (Method C) with the third highest priority. Method C requires the use of two separate e-payment accounts (Accounts A and C) with Account A having a pre-payment balance of 950 dollars and post-payment balance of 500 dollars, and Account C having a pre-payment balance of 50 dollars, and post-payment balance of 0 dollars. Since the funds available from Account A cover only 450 of the 500 dollars required for the purchase, the shortfall is covered by using funds available in Account C.

Finally, window 33 displays a payment account “Method D” with the fourth highest priority, a pre-payment balance of 800 dollars, and a post-payment balance of 300 dollars. Additional “triple points” information is also displayed. Method D is associated to another single account. By displaying the payment method candidates on a display of the mobile phone 10 along with the account balances before and after the payment with points and other information, the user of the mobile phone 10 can quickly select a payment method optimum for the user.

Referring back to FIG. 2, after the presentation of the payment method candidates at STEP S205 in a manner shown in FIG. 4, the user selects (STEP 205) the payment method to be used and touches a touch panel, which is the input/output section 16, of the mobile phone 10 to register the selection. After the selection and input of the payment method, the electronic payment controlling section 11 of the mobile phone 10 notifies the merchant terminal 20 of the ID of the e-payment accounts to be used in the selected payment method and the amount of payment to be made from each account. After the notification, payment processing is executed (STEP 207) between the merchant terminal 20 and the mobile phone 10. When the payment method with the third highest priority is selected as described above, the following payment information is supplied to the merchant terminal 20 from the mobile phone 10.

Account C: 50 dollars

Account A: 450 dollars

The electronic payment unit 24 of the merchant terminal 20 executes payment processing corresponding to each user account involved in the payment in cooperation with the electronic payment unit 14 of the mobile phone 10

An embodiment where payment method candidates are not displayed on the screen of the mobile phone 10 at STEP S205 will now be described. As examples of the case where the payment methods candidates are not displayed, there are cases where the number of payment method candidates is narrowed down to only one on the basis of the above-described conditions and where the merchant terminal 20 at a store can handle only one kind of electronic money. In addition, there is a case where a user previously sets a condition to automatically execute payment with the payment method candidate with the highest priority among the payment method candidates. When the payment method is automatically decided at the merchant terminal, the electronic payment controlling section 11 automatically starts the payment processing at STEP S207. When the payment method is automatically decided, a labor and a time for a user to select the payment method can be saved by executing the payment without displaying the payment method candidates in this manner.

The information storage section 15 then stores the payment method selected at STEP S206 as a payment history (STEP S208). The payment history includes a store ID, a payment method, an amount of payment of the payment information, and utilization statistical information, such as a number of times of the use of the electronic money or the store and the point. Since the payment history reveals not only the frequently used payment method but also a frequently visited store based on the store ID and the number of times of the use of the store, an action pattern or the like can be estimated. In addition, the information stored at STEP S208 can be used in the selection of the payment method candidates at STEP 204. Furthermore, when a user makes payment with cash, a cash utilization history may be stored by placing the mobile phone 10 over the electronic payment terminal 20. This allows the expenditure with the electronic money and the cash to be managed in an integrated manner in the mobile phone 10 and the mobile phone 10 can be utilized as a housekeeping account book.

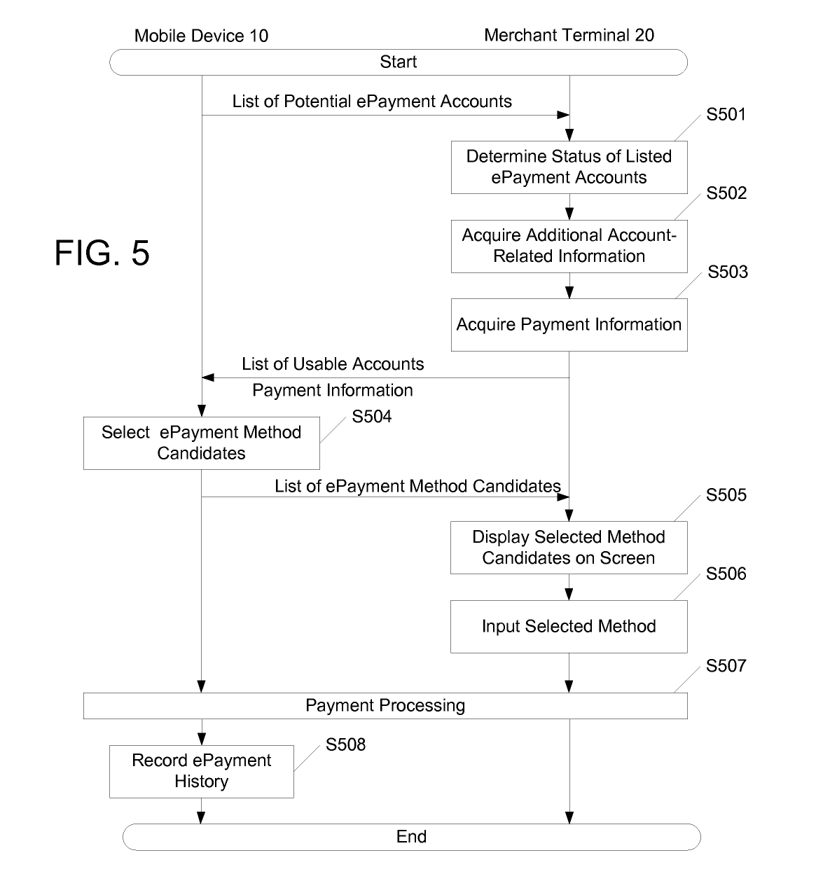

Processing according to a method different from that of FIG. 2 will be described next. FIG. 5 is a diagram showing a processing flow of electronic money payment processing where payment method candidates are displayed only on the merchant terminal 20 of the electronic payment system 1. In response to a user's moving the mobile phone 10 into the proximity of the communication unit 22 of the merchant terminal 20, the electronic payment terminal 20 starts the processing. After the start of the processing, the merchant 20 is sent a list of user e-payment accounts registered in the mobile phone 10. The account information acquiring unit 23 determines the balances (STEP S501) of the accounts in the list. Regarding the e-payment accounts determined to be usable in the merchant terminal 20, the electronic money information acquiring unit 23 acquires additional information (STEP S502) for each account from a payment server (not shown) connected to the merchant terminal 20.

Subsequently, the information acquiring unit 23 acquires payment information, such as an amount of payment required for the transaction and a store ID (STEP S503). The electronic payment controlling section 21 then sends the mobile phone 10 the account list and the payment information acquired at STEPs S501, S502, and S503. The electronic payment candidate selecting unit 13 selects payment method candidates using the account list and the payment information provided by the merchant terminal 20 (STEP S504). After the selection of the payment method candidates at STEP S504, the electronic payment controlling section 11 identifies the candidates to the merchant terminal 20. The identified payment method candidates are displayed on the input/output section 26, e.g., a touch panel, of the electronic payment terminal 20 in STEP S505.

The user decides on the payment method and touches the touch panel of the electronic payment terminal 20 to select the elected method, whereby the electronic payment controlling section 21 receives the input (STEP S506). However, if the user is not required to finally select the payment method candidate, the payment method candidates are not displayed on merchant terminal 20. Cases where the payment method candidates are not displayed are those described in the description of the processing flow of the electronic money payment processing in the case of displaying the payment method candidates on the mobile phone 10. When the payment method is automatically decided, STEPs S505 and S506 are omitted. After the decision of the payment method, the electronic payment units 14 and 24 execute payment processing between the merchant terminal 20 and the mobile phone 10 (STEP S507). Finally, the information storage section 15 stores the payment method selected at STEP S506 as a payment history (STEP S508).

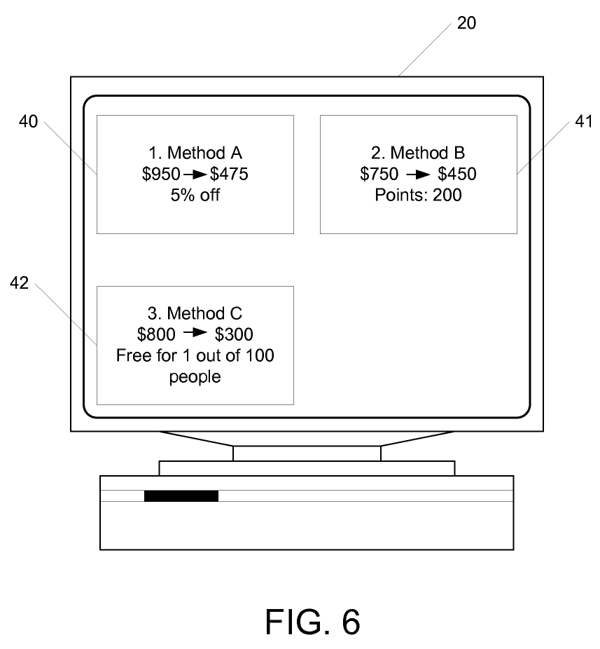

FIG. 6 is an illustration of a screen of the merchant terminal 20 displaying payment method candidates. This is a result of a case where the number of presented payment method candidates is set to four and a purchase of 500 dollars is made. Only payment methods that match the conditions of the selection method are displayed when the number of payment methods matching the condition is less than four, even if it is possible to display four candidates. A window 40 displays a payment method with the highest priority using Account A, remaining balances before and after the payment, and a discount rate. Since the price is reduced by 5%, the amount of payment is equal to 475 dollars. In addition, a window 41 displays a payment method with the second highest priority using only Account B, remaining balances before and after the payment, and the point to be used. The point equivalent to 200 dollars is used and the shortfall of 300 dollars will be paid with the account. Furthermore, a window 42 displays a payment method with the third highest priority using Account D, remaining balances before and after the payment, and campaign information of “free for one out of 100 people!!”. In such a manner, the electronic payment terminal 20 displays the payment method candidates as in the case of the display of the mobile phone 10.

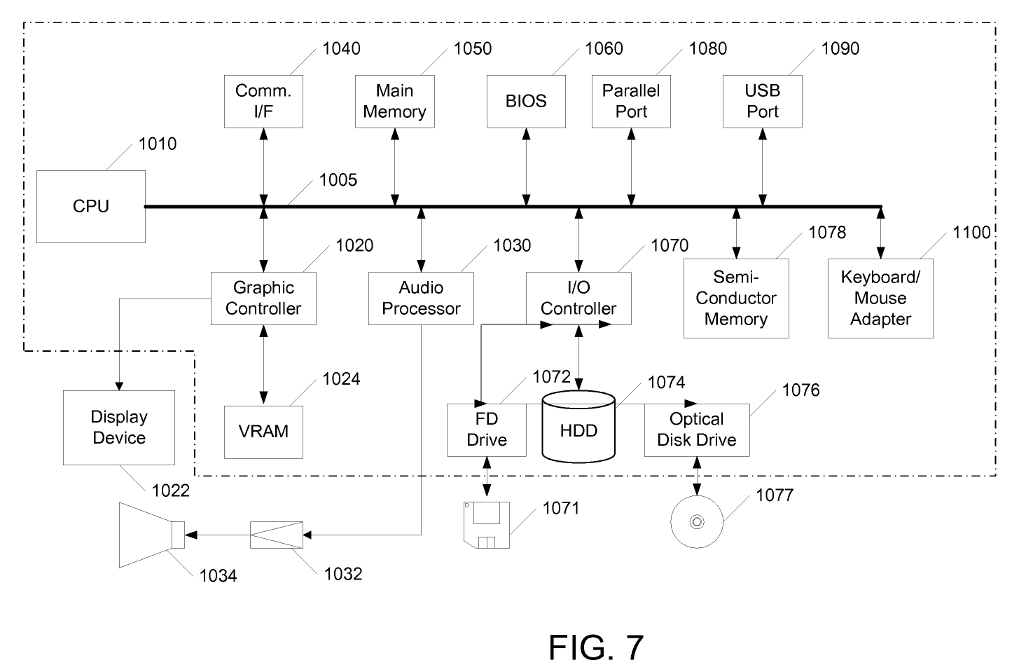

FIG. 7 is a diagram showing an information processing apparatus 400 as an example of a typical hardware configuration of the merchant terminal 20 described in FIG. 1. An example of a hardware configuration of this information processing apparatus 400 will be shown below. The information processing apparatus 400 includes a CPU (Central Processing Unit) 1010, a bus 1005, a communication I/F 1040, a main memory 1050, a BIOS (Basic Input Output System) 1060, a parallel port 1080, a USB port 1090, a graphic controller 1020, a VRAM 1024, an audio processor 1030, an I/O controller 1070, and input means, such as a keyboard/mouse adaptor 1100. Storage means, such as a flexible disk (FD) drive 1072, a hard disk 1074, an optical disk drive 1076, and a semiconductor memory 1078, can be connected to the I/O controller 1070.

An amplifier circuit 1032 and a speaker 1034 are connected to the audio processor 1030. Additionally, a display device 1022 is connected to the graphic controller 1020.

The BIOS 1060 stores a boot program executed by the CPU 1010 at the time of booting of the information processing apparatus 400 and hardware-dependent programs depending on hardware of the information processing apparatus 400. The FD (flexible disk) drive 1072 reads out programs or data from a flexible disk 1071 and supplies the programs or the data to the main memory 1050 or the hard disk 1074 through the I/O controller 1070.

For example, a DVD-ROM drive, a CD-ROM drive, a DVD-RAM drive, or a CD-RAM drive can be used as the optical disk drive 1076. In this case, it is necessary to use an optical disk 1077 corresponding to each drive. The optical disk drive 1076 reads programs or data from the optical disk 1077 and may supply the program or the data to the main memory 1050 or the hard disk 1074 through the I/O controller 1070.

Computer programs supplied to the information processing apparatus 400 may be stored on a recording medium, such as the flexible disk 1071, the optical disk 1077, or a memory card, and provided by a user. The computer programs are read out from the recording medium through the I/O controller 1070 or are downloaded through the communication I/F 1040, thereby being installed in the information processing apparatus 400 and executed. Since the operations that the computer programs cause the information processing apparatus to perform are the same as those performed in the apparatus having been already described, the description thereof is omitted.

The computer programs described above may be stored on external recording media. In addition to the flexible disk 1071, the optical disk 1077, or the memory card, a magneto-optical recording medium such as an MD and a tape medium can be used as the recording media. In addition, the computer programs may be supplied to the information processing apparatus 400 via a communication network using a storage device, such as a hard disk or an optical disk library, provided in a server system connected to a private communication network or the Internet as the recording medium.

The information processing apparatus 400 has been described in the above example. Functions similar to those of the above-described information processing apparatus can be realized by installing programs, having the functions described regarding the information processing apparatus, in a computer and causing the computer to function as the information processing apparatus. Accordingly, the information processing apparatus that is described as one embodiment of the present invention can be realized by a method and a computer program thereof.

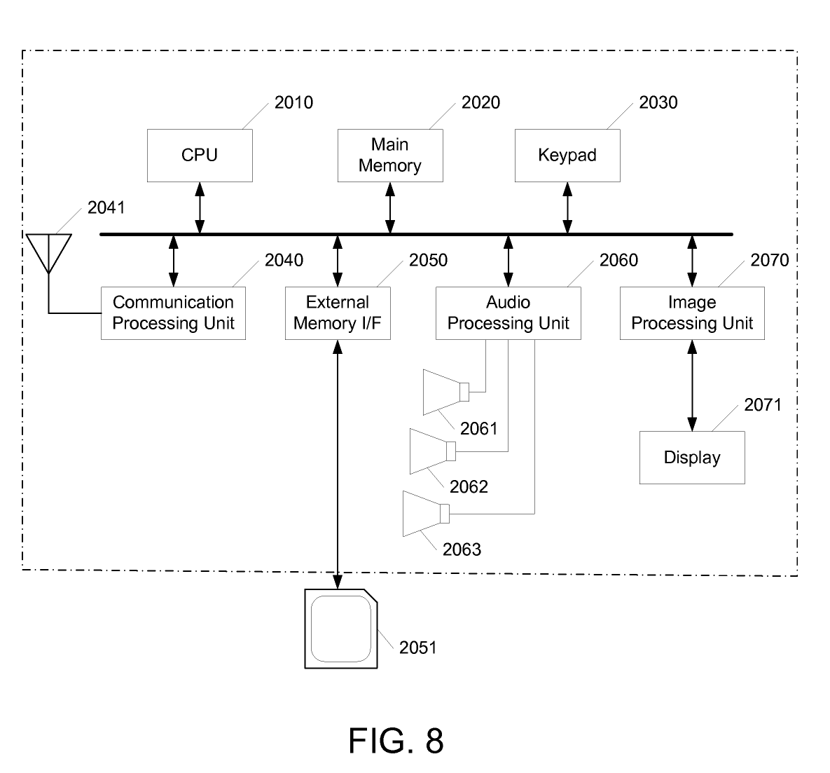

FIG. 8 is a diagram showing a mobile phone apparatus 500 as an example of a typical hardware configuration of the mobile phone 10 described in FIG. 1. An example of the hardware configuration of this mobile phone apparatus 500 will be shown below. The mobile phone apparatus 500 includes a CPU 2010, a main memory 2020, a keypad 2030, a communication processing unit 2040, an external memory I/F 2050, an audio processing unit 2060, and an image processing unit 2070. In addition, the mobile phone apparatus 500 may include a camera function unit, a TV broadcast receiving unit, an RFID (Radio Frequency Identification) function unit.

The CPU 2010 is a processing unit for executing programs stored in the main memory 2020. The CPU 2010 performs processing for controlling each functional unit of the mobile phone apparatus 500 and realizes each functional unit. The main memory 2020 is constituted by a RAM (Random Access Memory) or the like and stores programs and data used for realizing each functional unit of the mobile phone apparatus 500. The main memory 2020 also operates as a working area of the CPU 2010.

The keypad 2030 includes numeral keys, arrow keys, and special-purpose keys. The form of the keypad is arbitrary and the keypad may be a touch panel or the like. In addition, the keypad 2030 receives user's input operations and outputs the input data to the CPU 2010. The data includes, for example, various kinds of data such as a content of a text message.

The communication processing unit 2040 is connected to a main antenna 2041 for performing wireless communication with a base station apparatus (not shown). The communication processing unit 2040 performs signal processing, such as demodulation, on communication data received from the base station apparatus and outputs the communication data to the CPU 2010. The communication processing unit 2040 also performs modulation on communication data fed from the CPU 2010 and transmits the communication data to the base station apparatus. In addition, the communication processing unit 2040 may perform communication using radio waves. Such a configuration allows the mobile phone apparatus 500 to perform communication with a reader terminal simply by being placed over the reader terminal.

The external memory I/F 2050 may be, for example, an SD memory card I/F and a mini SD card I/F. The external memory I/F 2050 can read out programs or data from an external memory 2051, such as an SD memory card and a mini SD card, and may supply the programs or data to the main memory 2020.

An audio output unit 2061, an audio input unit 2062, and a speaker 2063 that outputs a ring alert or the like are connected to the audio processing unit 2060. A display 2071 is connected to the image processing unit 2070. The display 2071 displays an incoming call notifying screen, a text message creation screen, and data of electronic money payment candidates fed from the CPU 2010.

Although the embodiments of the present invention have been described above, the present invention is not limited to the above-described embodiments. In addition, advantages described in the embodiments of the present invention are only the most preferable advantages resulting from the present invention, and the advantages of the present invention are not limited to those described in the embodiments and the examples of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A mobile apparatus for use in an electronic payment system comprising a merchant terminal, said mobile apparatus comprising:
a memory component for storing a list of electronic payment accounts that might be used in completing an electronic payment transaction;
a transmitting unit for sending said list to the merchant terminal;
a receiving unit for receiving account-related information back from the merchant terminal, said account-related information comprising account identifiers for each electronic payment account on the list and additional information relating to one or more of the electronic payment accounts on the list;
a payment method selection component for using account-related information received from the merchant terminal to generate a set of payment method candidates, each payment method including the use of at least one of the electronic payment accounts; and
a user input component for receiving a user's selection of one of the payment method candidates in the generated set.

2. A mobile apparatus according to claim 1 further comprising a display screen for providing a visual representation of one or more of the payment method candidates in the generated set.

3. A mobile apparatus according to claim 2 wherein said transmitting unit is further used to send the identity of the selected payment method candidate to the merchant terminal.

4. A mobile apparatus according to claim 3 wherein said account-related information used in said payment method selection component comprises the current balance in an electronic payment account and the size of the payment required to be made using the account if the electronic payment transaction is completed.

5. A mobile apparatus according to claim 4 wherein said account-related information further comprises information relating to incentives for a user to make use of the account in completing an electronic payment transaction.

6. A method practiced in a mobile apparatus used in an electronic payment system, said mobile apparatus including at least a memory component, a transmitting unit, a receiving unit and a payment method selection component, said method comprising:
storing, in the memory component, a list of electronic payment accounts that might be used in completing an electronic payment transaction;
sending said list to the merchant terminal;
receiving account-related information back from the merchant terminal, said account-related information comprising account identifiers for each electronic payment account on the list and additional information relating to one or more of the electronic payment accounts on the list;
using account-related information received from the merchant terminal, generating a set of payment method candidates, each payment method including the use of at least one of the electronic payment accounts; and
receiving a user's selection of one of the payment method candidates in the generated set.

7. A method according to claim 6 further comprising providing, on a display screen in the mobile apparatus, a visual representation of one or more of the payment method candidates in the generated set.

8. A method according to claim 7 further comprising sending the identity of the selected payment method candidate to the merchant terminal.

9. A method according to claim 8 wherein said account-related information used in said payment method selection component comprises the current balance in an electronic payment account and the size of the payment required to be made using the account if the electronic payment transaction is completed.

10. A method according to claim 9 wherein said account-related information further comprises information relating to incentives for a user to make use of the account in completing an electronic payment transaction.

11. A computer program product for use in a mobile apparatus used in an electronic payment system, said system including a merchant terminal, said computer program product comprising a computer usable medium having computer usable program code embodied therewith, said computer usable program code comprising:
computer usable program code configured to store, in the memory component, a list of electronic payment accounts that might be used in completing an electronic payment transaction;
computer usable program code configured to send said list to the merchant terminal;
computer usable program code configured to receive account-related information back from the merchant terminal, said account-related information comprising account identifiers for each electronic payment account on the list and additional information relating to one or more of the electronic payment accounts on the list;
computer usable program code configured to use account-related information received from the merchant terminal, generating a set of payment method candidates, each payment method including the use of at least one of the electronic payment accounts; and
computer usable program code configured to receive a user's selection of one of the payment method candidates in the generated set.

12. A computer program product according to claim 12 further comprising computer usable program code configured to provide a visual representation, on a display screen in the mobile apparatus, of one or more of the payment method candidates in the generated set.

13. A computer program product according to claim 12 further comprising computer usable program code configured to send the identity of the selected payment method candidate to the merchant terminal.

14. A computer program product according to claim 13 wherein said account-related information used in said payment method selection component comprises the current balance in an electronic payment account and the size of the payment required to be made using the account if the electronic payment transaction is completed.

15. A computer program product according to claim 14 wherein said account-related information further comprises information relating to incentives for a user to make use of the account in completing an electronic payment transaction.

16. A merchant terminal for use in an electronic payment system, said system including at least one mobile apparatus used by a user, said merchant terminal comprising:
a receiving unit for receiving a list of electronic payment accounts from the mobile apparatus;
an information acquiring unit for retrieving account-related information for one or more of the accounts included in the received list; and
a transmitting unit for returning the list of electronic payment accounts to the mobile apparatus along with account-related information retrieved by said information acquiring unit.

17. A method practiced in a merchant terminal used in an electronic payment system, said system including at least one mobile apparatus used by a user, said method comprising:
receiving a list of electronic payment accounts from the mobile apparatus;
retrieving account-related information for one or more of the accounts included in the received list; and
returning the list of electronic payment accounts to the mobile apparatus along with retrieved, account-related information.

18. A method according to claim 17 wherein the retrieved account-related information further comprises the account identity, the current balance in the account and any current incentives for using the account in an electronic payment transaction.

19. A computer program product for use in a merchant terminal used in an electronic payment system, said system further including at least one mobile apparatus used by a user of the electronic payment system, said computer program product comprising computer usable medium having computer usable program code embodied therewith, said computer usable program code comprising:
computer usable program code configured to receive a list of electronic payment accounts from the mobile apparatus;
computer usable program code configured to retrieve account-related information for one or more of the accounts included in the received list; and
computer usable program code configured to return the list of electronic payment accounts to the mobile apparatus along with retrieved account-related information.

20. A computer program product according to claim 19 wherein the retrieved account-related information further comprises the account identity, the current balance in the account and any current incentives for using the account in an electronic payment transaction.
